(19) United States
(12) Patent Application Publication
(10) Pub. No.: US 2023/0292676 A1
(43) Pub. Date: Sep. 21, 2023

(54) INTELLIGENT ILLUMINATION SEEDLING INCUBATOR FOR SORGHUM CULTURE

(71) Applicant: YANGZHOU UNIVERSITY, Yangzhou City (CN)

(72) Inventors: Yanqing WU, Yangzhou City (CN); Jiao LIU, Yangzhou City (CN); Guisheng ZHOU, Yangzhou City (CN)

(73) Assignee: YANGZHOU UNIVERSITY, Yangzhou City (CN)

(21) Appl. No.: 18/183,811

(22) Filed: Mar. 14, 2023

(30) Foreign Application Priority Data
Mar. 17, 2022 (CN) 202220578692.8

(51) Int. Cl. A01G 9/24; A01G 9/029

(52) U.S. Cl. CPC A01G 9/246; A01G 9/029; A01G 9/249

(57) ABSTRACT

Disclosed is an intelligent illumination seedling incubator for sorghum culture. The incubator comprises an incubator body and a culture component. At least one installation opening is formed in the forward side of the incubator body. The culture component comprises culture trays and a vertically arranged connecting shaft which is connected to the incubator body. A plurality of non-circular support pillars are arranged on the connecting shaft at intervals in the height direction. The culture trays are installed in the incubator body through the installation opening. A clamping opening is formed in the culture tray. A connecting sink with the same shape as the support pillar is formed in the downward end of the culture tray inside the clamping opening. After the culture tray is clamped into the connecting shaft through the clamping opening, the culture tray is exactly inserted on the support pillar through the connecting sink. The incubator is simple in structure and convenient in installation, and the height and position of the culture tray are adjustable.

### CROSS-REFERENCE TO RELATED APPLICATION

This patent application claims the benefit and priority of Chinese Patent Application 202220578692.8, filed with the China National Intellectual Property Administration on Mar. 17, 2022, the disclosure of which is incorporated by reference herein in its entirety as part of the present application.

### TECHNICAL FIELD

The present disclosure relates to the field of agricultural technology, in particular to an intelligent illumination seedling incubator for sorghum culture.

### BACKGROUND

Plant seedlings refer to young plants in the early growth stage after seed germination. Seedling culture refers to seedling culture in nursery gardens, hotbeds or greenhouses to be transplanted into the land. Sorghum seedling culture directly affects the growth quality and survival rate in the process of sorghum culture, and seedlings need high requirements on the environment. In order to maintain the stability of seedling growth environment and improve the culture efficiency, seedling culture can be performed through incubators.

The existing plant incubator is generally a vertical movable box. A plurality of trays for placing seedlings are arranged in the box, and the positions of the trays are not adjustable, so the installation is inconvenient.

### SUMMARY

The purpose of this part is to summarize some aspects of the embodiments of the present disclosure and briefly introduce some preferred embodiments. Some simplification or omission may be made in this part, the abstract of the specification and the name of the present disclosure to avoid obscuring the purpose of this part, the abstract of the specification and the name of the present disclosure, and such simplification or omission cannot be configured to limit the scope of the present disclosure.

In view of the problems existing in the above and/or existing germination accelerating technology, the present disclosure has been proposed.

Therefore, the purpose of the present disclosure is to provide an intelligent illumination seedling incubator for sorghum culture. The incubator is simple in structure and convenient to install. The position of the culture tray is adjustable.

In order to solve the technical problems, the present disclosure provides the following technical scheme. An intelligent illumination seedling incubator for sorghum culture includes:
an incubator body, at least one installation opening being formed in the forward side of the incubator body; and
a culture component, the culture component including culture trays and a vertically arranged connecting shaft which is connected to the incubator body, a plurality of non-circular support pillars being arranged on the connecting shaft at intervals in the height direction, the culture trays being installed in the incubator body through the installation opening, a clamping opening being formed in the culture tray, a connecting sink with the same shape as the support pillar being formed in the downward end of the culture tray inside the clamping opening, and after the culture tray is clamped into the connecting shaft through the clamping opening, the culture tray being exactly inserted on the support pillar through the connecting sink.

As a preferred embodiment of the intelligent illumination seedling incubator for sorghum culture in the present disclosure, at least one heating pipe is connected into the incubator body, and the heating pipe is arranged far away from the installation opening.

As a preferred embodiment of the intelligent illumination seedling incubator for sorghum culture in the present disclosure, the inner wall of the incubator body is also connected with an intelligent lamp, and the intelligent lamp is arranged relative to the support pillar and far away from the installation opening.

As a preferred embodiment of the intelligent illumination seedling incubator for sorghum culture in the present disclosure, the connecting shaft is rotatably connected to the incubator body.

As a preferred embodiment of the intelligent illumination seedling incubator for sorghum culture in the present disclosure, the lower part of the connecting shaft is connected with a blade.

As a preferred embodiment of the intelligent illumination seedling incubator for sorghum culture in the present disclosure, two heating pipes are arranged, and the two heating pipes are symmetrically arranged about the axis of the connecting shaft.

As a preferred embodiment of the intelligent illumination seedling incubator for sorghum culture in the present disclosure, the height area where all the support pillars are located is enveloped with the intelligent lamp.

The present disclosure has the following beneficial effects. The culture tray is clamped into the connecting shaft through the clamping opening, and the connecting sink is exactly supported on the support pillar, so that the installation of the culture tray and the connecting shaft is realized, and the installation is convenient. The connecting shaft can rotate, and seedlings in the culture trays can receive uniform illumination, so that the culture quality is improved. When the connecting shaft rotates, the blade also rotates to promote heat inside the incubator body to flow, so that the temperature in the incubator is more uniform. A plurality of support pillars are arranged on the connecting shaft, and the culture trays can be installed according to the requirements of culture density, so that the application range is wider.

### BRIEF DESCRIPTION OF THE DRAWINGS

To describe the technical schemes in the embodiments of the present discourse more clearly, the following briefly describes the attached figures required for describing the embodiments. Apparently, the attached figures in the following descriptions show merely some embodiments of the present disclosure, and a person of ordinary skill in the art may derive other drawings from these attached figures without creative efforts.

FIG. 1 is a three-dimensional structure diagram I of the present disclosure.

FIG. 2 is a three-dimensional structure diagram II of the present disclosure.

FIG. 3 is a reference arrow view of the present disclosure.

FIG. 4 is an enlarged partial view at the position of A in FIG. 3.

FIG. 5 is a three-dimensional structure diagram of a culture tray in the present disclosure.

Reference signs: 100, culture component; 101, heating pipe; 102, culture tray; 102a, clamping opening; 102b, connecting sink; 103a, support pillar; 103, connecting shaft; 104, intelligent lamp; 105, blade; 200, incubator body; 201, installation opening.

### DETAILED DESCRIPTION OF THE EMBODIMENTS

To make the foregoing objective, features and advantages of the present disclosure clearer and more comprehensible, the specific embodiment of the present disclosure is further described in detail below with reference to the attached figures.

Numerous specific details are set forth in the following description to provide thorough understanding of the present disclosure, but the present disclosure may be implemented otherwise than as described herein. Those skilled in the art can make similar promotion without violating the connotation of the present disclosure. Therefore, the scope of the present disclosure is not limited by the specific embodiments disclosed below.

And then, “one embodiment” or “an embodiment” referred to herein refers to a specific feature, structure or characteristic that can be included in at least one implementation of the present disclosure. The appearances of “in one embodiment” in different places in this specification do not all refer to the same embodiment, neither separated or selective embodiments mutually exclusive with other embodiments.

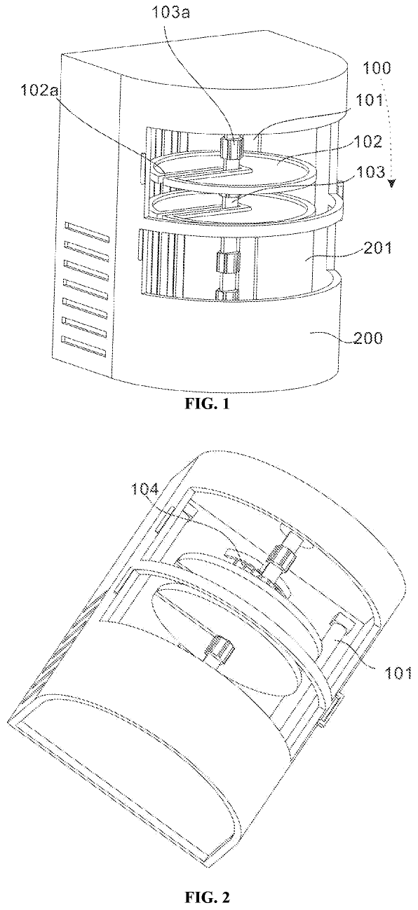

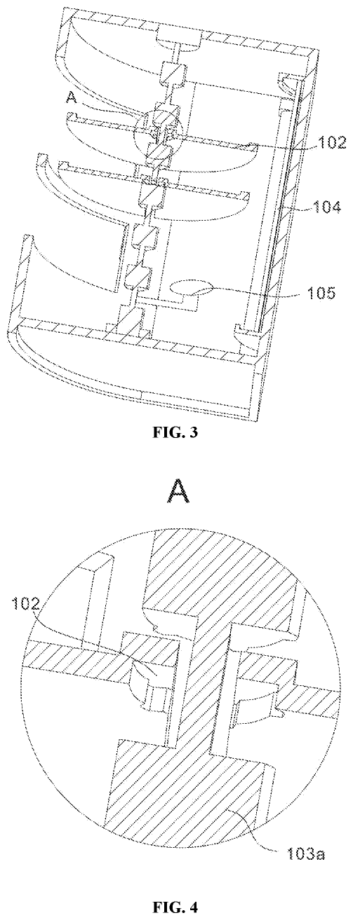

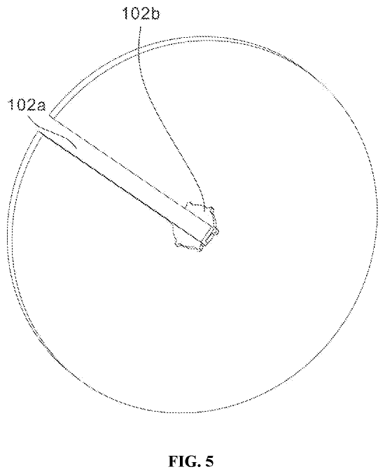

Referring to FIG. 1 to FIG. 5, the embodiment provides an intelligent illumination seedling incubator for sorghum culture. The incubator is simple in structure. Culture trays 102 are convenient to install. Seedlings are heated more uniformly.

The intelligent illumination seedling incubator for sorghum culture includes an incubator body 200 and a culture component 100. At least one installation opening 201 is formed in the forward side of the incubator body 200.

The culture component 100 includes culture trays 102 and a vertically arranged connecting shaft 103 which is connected to the incubator body 200. The connecting shaft 103 is non-circular. The connecting shaft 103 is rotatably connected to the incubator body 200. In practice, a driving device such as a motor is fixedly installed in the incubator body 200. The driving device is connected with the connecting shaft 103. The lower part of the connecting shaft 103 is connected with a blade 105. A plurality of non-circular support pillars 103a are arranged on the connecting shaft 103 at intervals in the height direction. The culture trays 102 are installed in the incubator body 200 through the installation opening 201. A clamping opening 102a is formed in the culture tray 102. A connecting sink 102b with the same shape as the support pillar 103a is formed in the downward end of the culture tray 102 inside the clamping opening 102a. After the culture tray 102 is clamped into the connecting shaft 103 through the clamping opening 102a, the culture tray 102 is exactly inserted on the support pillar 103a through the connecting sink 102b.

Further, at least one heating pipe 101 is connected into the incubator body 200. In the embodiment, two heating pipes 101 are arranged, and the two heating pipes 101 are symmetrically arranged about the axis of the connecting shaft 103. The heating pipe 101 is arranged far away from the installation opening 201.

Further, the inner wall of the incubator body is also connected with an intelligent lamp 104, and the intelligent lamp 104 is arranged relative to the support pillar 103a and far away from the installation opening 201. The height area where all the support pillars 103a are located is enveloped with the intelligent lamp 104.

When the culture tray 102 is installed, the culture tray 102 is clamped into the connecting shaft 103 through the clamping opening 102a, so that the connecting sink 102a is exactly supported on the support pillar 103a. The installation of the culture tray 102 and the connecting shaft 103 is realized, and the installation is convenient. The intelligent lamp 104 is provided with a photosensitive sensor. A controller for controlling the illumination intensity of the intelligent lamp 104 is arranged in the incubator body 200. The photosensitive sensor transmits an illumination signal to the controller in real time. The controller automatically adjusts the illumination intensity of the intelligent lamp 104 according to the internal illumination of the incubator body 200, so that the manpower is saved, and the culture efficiency is improved. The heating pipe 101 is provided with a temperature sensor. The temperature sensor transmits collected temperature data to the controller. The controller controls the heating pipe 101 to heat according to a received temperature signal. In actual use, the installation opening 201 is provided with an incubator door, and the installation opening 201 is covered with incubator door. When working, the driving device operates, the connecting shaft 103 rotates, and the seedlings in the culture trays 102 can receive uniform illumination, so that the culture quality is improved. When the connecting shaft 103 rotates, the blade 105 also rotates to promote heat inside the incubator body 200 to flow, so that the temperature in the incubator body 200 is more uniform. A plurality of support pillars 103a are arranged on the connecting shaft 103, so that the culture trays 102 can be installed according to the requirements of culture density, and the application range is wider.

When in use, the incubator is placed at a proper position. After the inside of the incubator is cleaned, the incubator is powered on. The seedlings to be cultivated are placed in the culture trays 102 as required, and then the culture trays 102 are placed in the incubator body 200. The angle of the connecting shaft 103 is adjusted to the outside of the narrow surface of the support pillar 103a. Then, the opening is aligned with the support pillar 103a of the connecting shaft 103, and the culture tray 102 is inserted in the connecting shaft 103. When the connecting shaft 103 is located at the center of the culture tray 102, the angle of the culture tray 102 is adjusted so that the clamping groove is in butt-joint with the support column 103a on the connecting shaft 103. The remaining culture trays 102 are installed on the connecting shaft 103 by repeating the above operation. The incubator door is closed, and the driving device is started. The temperature and illumination are adjusted according to the growth demand of the seedlings, and the work starts. The connecting shaft 103 rotates slowly and uniformly. The intelligent lamp 104 and the heating pipe 101 adjust the illumination and temperature according to the program. The blade 105 at the bottom of the connecting shaft 103 rotates along with the connecting shaft 103 at a constant speed. At the same time, the blade 105 drives air inside the incubator body 200 to move, so that the heat inside the incubator body 200 is uniformly distributed inside the incubator body 200. The intelligent lamp 104 is automatically adjusted according to the brightness inside the incubator body 200, so that the illumination is maintained at a rated value.

It is noted that the above-mentioned embodiments are only used for illustrating the technical scheme of the present disclosure but not restricting the scope of protection of the present disclosure. The front-and-back direction mentioned in this application referring to the front view as a reference is the direction perpendicular to the paper surface parallel to the front-and-back direction. Although the present disclosure is described in detail by reference to a better embodiment, those ordinary skilled in the art should understand that the technical scheme of the present disclosure can be amended or equally substituted but not departing from the purpose and scope of the technical scheme of the present disclosure and should be contained in the scope of claims of the present disclosure.

1-7. (canceled)

8. An intelligent illumination seedling incubator for sorghum culture, comprising:
an incubator body, at least one installation opening being formed in a forward side of the incubator body; and
a culture component, the culture component comprising culture trays and a vertically arranged connecting shaft which is connected to the incubator body, a plurality of non-circular support pillars being arranged on the connecting shaft at intervals in a height direction, the culture trays being installed in the incubator body through the installation opening, a clamping opening being formed in the culture tray, a connecting sink with a same shape as the support pillar being formed in a downward end of the culture tray inside the clamping opening, and after the culture tray is clamped into the connecting shaft through the clamping opening, the culture tray being exactly inserted on the support pillar through the connecting sink.

9. The intelligent illumination seedling incubator for sorghum culture according to claim 8, wherein at least one heating pipe is connected into the incubator body, and the heating pipe is arranged far away from the installation opening.

10. The intelligent illumination seedling incubator for sorghum culture according to claim 9, wherein an inner wall of the incubator body is also connected with an intelligent lamp, and the intelligent lamp is arranged relative to the support pillar and far away from the installation opening.

11. The intelligent illumination seedling incubator for sorghum culture according to claim 8, wherein the connecting shaft is rotatably connected to the incubator body.

12. The intelligent illumination seedling incubator for sorghum culture according to claim 9, wherein the connecting shaft is rotatably connected to the incubator body.

13. The intelligent illumination seedling incubator for sorghum culture according to claim 10, wherein the connecting shaft is rotatably connected to the incubator body.

14. The intelligent illumination seedling incubator for sorghum culture according to claim 11, wherein a lower part of the connecting shaft is connected with a blade.

15. The intelligent illumination seedling incubator for sorghum culture according to claim 12, wherein a lower part of the connecting shaft is connected with a blade.

16. The intelligent illumination seedling incubator for sorghum culture according to claim 13, wherein a lower part of the connecting shaft is connected with a blade.

17. The intelligent illumination seedling incubator for sorghum culture according to claim 10, wherein two heating pipes are arranged, and the two heating pipes are symmetrically arranged about an axis of the connecting shaft.

18. The intelligent illumination seedling incubator for sorghum culture according to claim 17, wherein a height area where all the support pillars are located is enveloped with the intelligent lamp.
